(19) United States
(12) Patent Application Publication
(10) Pub. No.: US 2015/0358599 A1
(43) Pub. Date: Dec. 10, 2015

(54) Method and Apparatus of Compatible Depth Dependent Coding

(71) Applicant: MEDIATEK INC., Hsin-Chu, (TW)

(72) Inventors: Jian-Liang LIN, Su'ao Township, Yilan County (TW); Kai ZHANG, Beijing (CN); Jicheng AN, Beijing City (CN)

(21) Appl. No.: 14/762,505

(22) PCT Filed: Apr. 11, 2014
(86) PCT No.: PCT/CN2014/075195

§ 371 Date: Jul. 22, 2015

Related U.S. Application Data
(63) Continuation of application No. PCT/CN2013/074165, filed on Apr. 12, 2013.

(51) Int. Cl. H04N 13/00; H04N 19/517; H04N 19/597; G06T 7/00

(52) U.S. Cl. CPC H04N 13/0048; G06T 7/0022; H04N 19/517; H04N 19/597; H04N 2013/0081

(57) ABSTRACT

A method for providing compatible depth-dependent coding and depth-independent coding in three-dimensional video encoding or decoding is disclosed. The compatible system uses a depth-dependency indication to indicate whether depth-dependent coding is enabled for a texture picture in a dependent view. If the depth-dependency indication is asserted, second syntax information associated with a depth-dependent coding tool is used. If the depth-dependent coding tool is asserted, the depth-dependent coding tool is applied to encode or decode the current texture picture using information from a previously coded or decoded depth picture. The syntax information related to the depth-dependency indication can be in Video Parameter Set (VPS), Sequence Parameter Set (SPS), Picture Parameter Set (PPS) or Slice Header.

### CROSS REFERENCE TO RELATED APPLICATIONS

The present invention is a National Phase Application of PCT Application No. PCT/CN2014/075195, filed on Apr. 11, 2014, which claims priority to PCT Patent Application, Serial No. PCT/CN2013/074165, filed on Apr. 12, 2013, entitled “Stereo Compatibility High Level Syntax”. The PCT Patent Applications are hereby incorporated by reference in their entireties.

### TECHNICAL FIELD

The present invention relates to three-dimensional video coding. In particular, the present invention relates to compatibility between systems utilizing depth dependent information and systems not relying on the depth dependent information in 3D video coding.

### BACKGROUND

Three-dimensional (3D) television has been a technology trend in recent years that is targeted to bring viewers sensational viewing experience. Multi-view video is a technique to capture and render 3D video. The multi-view video is typically created by capturing a scene using multiple cameras simultaneously, where the multiple cameras are properly located so that each camera captures the scene from one viewpoint. The multi-view video with a large number of video sequences associated with the views represents a massive amount data. Accordingly, the multi-view video will require a large storage space to store and/or a high bandwidth to transmit. Therefore, multi-view video coding techniques have been developed in the field to reduce the required storage space and the transmission bandwidth. A straightforward approach may simply apply conventional video coding techniques to each single-view video sequence independently and disregard any correlation among different views. Such straightforward techniques would result in poor coding performance.

In order to improve multi-view video coding efficiency, multi-view video coding always exploits inter-view redundancy. The disparity between two views is caused by the locations and angles of the two respective cameras. Since all cameras capture the same scene from different viewpoints, multi-view video data contains a large amount of inter-view redundancy. To exploit the inter-view redundancy, coding tools utilizing disparity vector (DV) have been developed for 3D-HEVC (High Efficiency Video Coding) and 3D-AVC (Advanced Video Coding). For example, Backward View Synthesis Prediction (BVSP) and Depth-oriented Neighboring Block Disparity Vector (DoNBDV) have been used to improve coding efficiency in 3D video coding.

The DoNBDV process utilizes Neighboring Block Disparity Vector (NBDV) process to derive a disparity vector (DV). The NBDV derivation process is described as follows. The DV derivation is based on the neighboring blocks of the current block, including spatial neighboring blocks as shown in FIG. 1A and temporal neighboring blocks as shown in FIG. 1B. The spatial neighboring block set includes the location diagonally across from the lower-left corner of the current block (i.e., A0), the location next to the left-bottom side of the current block (i.e., A1), the location diagonally across from the upper-left corner of the current block (i.e., B2), the location diagonally across from the upper-right corner of the current block (i.e., B0), and the location next to the top-right side of the current block (i.e., B1). As shown in FIG. 1B, the temporal neighboring block set includes the location at the center of the current block (i.e., B_{CTR}) and the location diagonally across from the lower-right corner of the current block (i.e., RB) in a temporal reference picture. Temporal block B_{CTR} may be used only if the DV is not available from temporal block RB. The neighboring block configuration illustrates an example that spatial and temporal neighboring blocks may be used to derive NBDV. Other spatial and temporal neighboring blocks may also be used to derive NBDV. For example, for the temporal neighboring set, other locations (e.g., a lower-right block) within the current block in the temporal reference picture may also be used instead of the center location. Furthermore, any block collocated with the current block can be included in the temporal block set. Once a block having a DV is identified, the checking process will be terminated. An exemplary search order for the spatial neighboring blocks in FIG. 1A may be (A1, B1, B0, A0, B2). An exemplary search order for the temporal neighboring blocks for the temporal neighboring blocks in FIG. 1B may be (BR, B_{CTR}). The spatial and temporal neighboring sets may be different for different modes or different coding standards. In the current disclosure, NBDV may refer to the DV derived based on the NBDV process. When there is no ambiguity, NBDV may also refer to the NBDV process.

The DoNBDV process enhances the NBDV by extracting a more accurate disparity vector (referred to as a refined DV in this disclosure) from the depth map. A depth block from coded depth map in the same access unit is first retrieved and used as a virtual depth for the current block. For example, during coding the texture in view 1 with the common test condition, the depth map in view 0 is already coded and available. Therefore, the coding of texture in view 1 can be benefited from the depth map in view 0. An estimated disparity vector can be extracted from the virtual depth shown in FIG. 2. The overall flow is as follows.

1. Use a derived DV (240) derived based on NBDV for the current block (210). The derived DV is used to locate the corresponding block (230) in the coded texture view by adding the derived DV (230) to the current block position 210′ (shown as dashed box in view 0).

2. Use the collocated depth block (230′) in the coded view (i.e., base view according to the conventional 3D-HEVC) as a virtual depth block (250) for the current block (coding unit).

3. Extract a disparity vector (i.e., a refined DV) for inter-view motion prediction from the maximum value in the virtual depth block retrieved in the previous step.

Backward View synthesis prediction (BVSP) is a technique to remove interview redundancies among video signal from different viewpoints, in which synthetic signal is used as references to predict a current picture in a dependent view. NBDV is first used to derive a disparity vector. The derived disparity vector is then used to fetch a depth block in the depth map of the reference view. A maximum depth value is determined from the depth block and the maximum value is converted to a DV. The converted DV will then be used to perform backward warping for the current PU. In addition, the warping operation may be performed at a sub-PU level precision, such as 8×4 or 4×8 blocks. In this case, a maximum depth value is picked for a sub-PU block and used for warping all the pixels in the sub-PU block. The BVSP technique is applied for texture picture coding as shown in FIG. 3. A corresponding depth block (320) of coded depth map in view 0 for a current texture block (310) in a dependent view (view 1) is determined based on the position of the current block and a DV (330) determined based on NBDV. The corresponding depth block (320) is used by the current texture block (310) as a virtual depth block. Disparity vectors are derived from the virtual block to back warp pixels in the current block to corresponding pixels in the reference texture picture. The correspondences (340 and 350) for two pixels (A and B in T1, and A′ and B′ in T0) are indicated in FIG. 3.

Both BVSP and DoNBDV utilize the coded depth picture from the base view for coding a texture picture in a dependent view. Accordingly, these Depth-Dependent Coding (DDC) methods can take advantage of the additional information from the depth map to improve the coding efficiency over the Depth-Independent Coding (DIC) scheme. Therefore, both BVSP and DoNBDV have been used in HEVC (High Efficiency Video Coding) based 3D Test Model (HTM) software as mandatory coding tools.

While DDC can improve coding efficiency over the DIC, the dependency between texture and depth pictures as required by the DDC will cause compatibility issues with prior systems that do not support depth maps. In the system without the DDC coding tools, texture pictures in dependent views can be encoded and decoded without the need of depth pictures, which means that stereo compatibility is supported in the DIC scheme. In the newer HTM software (e.g., HTM version 6), however, texture pictures in dependent views cannot be encoded or decoded without base-view depth pictures. In the DDC case, the depth map has to be coded and will take up some available bitrate. In the stereo scenario (i.e., only two views), the depth map of the base view may represent a sizeable overhead, the gain in coding efficient may be significantly offset by the overhead required by the depth map in the base view. Therefore, the DDC coding tools may not necessarily be desirable in the stereo case or in a case with a limited number of views. FIG. 4 shows an example for a stereo system having two views. In a DIC scheme, only bitstreams V0 and V1 associated with texture pictures in view 0 and view 1 need to be extracted to decode the texture pictures. In a DDC scheme, however, bitstream D0 associated with depth picture in view 0 has to be extracted as well. Therefore, the depth picture in a base view is always coded in a DDC 3D coding system. This may not be desirable when only two views or only a small number of views is used.

### SUMMARY

A method for providing compatible depth-dependent coding and depth-independent coding in three-dimensional video encoding and decoding is disclosed. The present invention uses a depth-dependency indication to indicate whether depth-dependent coding is enabled for a texture picture in a dependent view. If the depth-dependency indication is asserted, second syntax information associated with a depth-dependent coding tool is used. If the depth-dependent coding tool is asserted, the depth-dependent coding tool is applied to encode or decode the current texture picture using information from a previously coded or decoded depth picture.

The syntax information related to the depth-dependency indication can be in Video Parameter Set (VPS), Sequence Parameter Set (SPS), Picture Parameter Set (PPS) or Slice Header. When the syntax information related to the depth-dependency indication is in Picture Parameter Set (PPS), the syntax information related to the depth-dependency indication is the same for all pictures in a same sequence. When the syntax information related to the depth-dependency indication is in Slice Header, the syntax information related to the depth-dependency indication is the same for all slices in a same picture.

The second syntax information associated with the depth-dependent coding tool can be in Video Parameter Set (VPS), Sequence Parameter Set (SPS), Picture Parameter Set (PPS) or Slice Header. If the second syntax information is in the Picture Parameter Set, the second syntax information in the Picture Parameter Set is the same for all pictures in a same sequence. If the second syntax information is in the Slice Header, the second syntax information in the Slice Header is the same for all slices in a same picture. The depth-dependent coding tool may correspond to Backward View Synthesis Prediction (BVSP), Depth-oriented Neighboring Block Disparity Vector (DoNBDV), or both. If the second syntax information associated with the depth-dependent coding tool is not present in the bitstream, the depth-dependent coding tool is not asserted.

### BRIEF DESCRIPTION OF DRAWINGS

FIGS. 1A-1B illustrates an example of spatial and temporal neighboring blocks used to derive the disparity vector based on the Neighboring Block Disparity Vector (NBDV) process.

FIG. 2 illustrates an example of the Depth-oriented NBDV (DoNBDV) process, where the derived disparity vector is used to locate a depth block according to Neighboring Block Disparity Vector (NBDV) process and a refined disparity vector is determined from depth values of the depth block.

FIG. 3 illustrates an example of Backward View Synthesis Prediction (BVSP) that utilizes coded depth map in a base view to perform backward warping.

FIG. 4 illustrates an example of depth dependency in depth depending coding and depth independent coding for a system with stereo views.

FIG. 5 illustrates a flow chart for an encoding system incorporating the compatible depth-dependent coding according to an embodiment of the present invention.

FIG. 6 illustrates a flow chart for a decoding system incorporating the compatible depth-dependent coding according to an embodiment of the present invention.

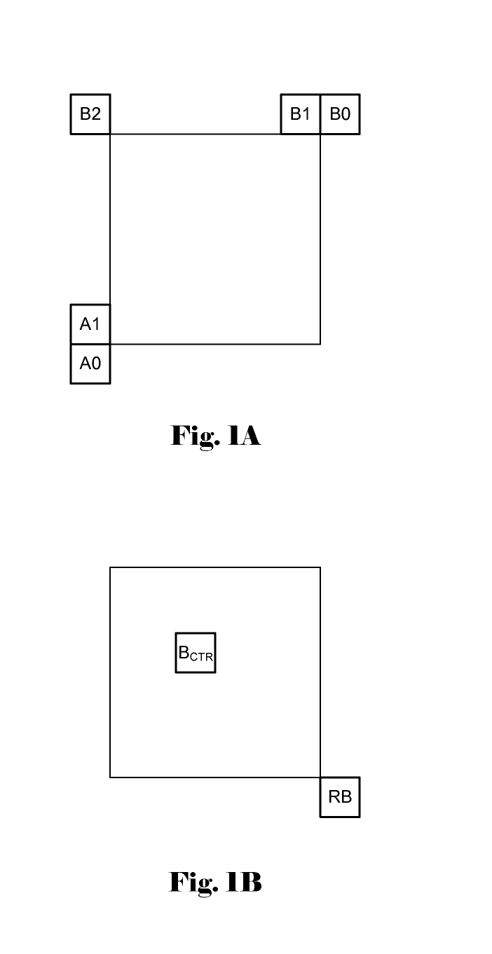

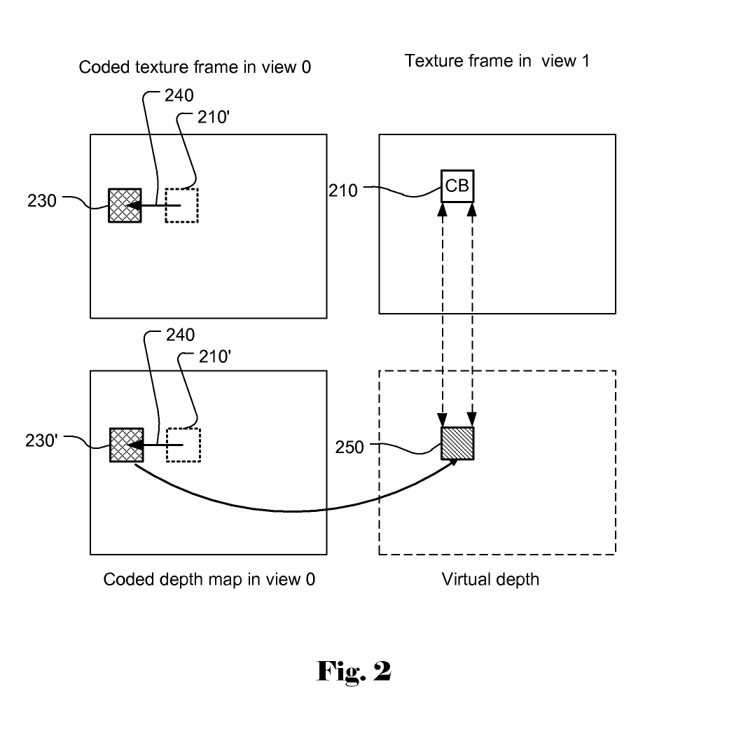

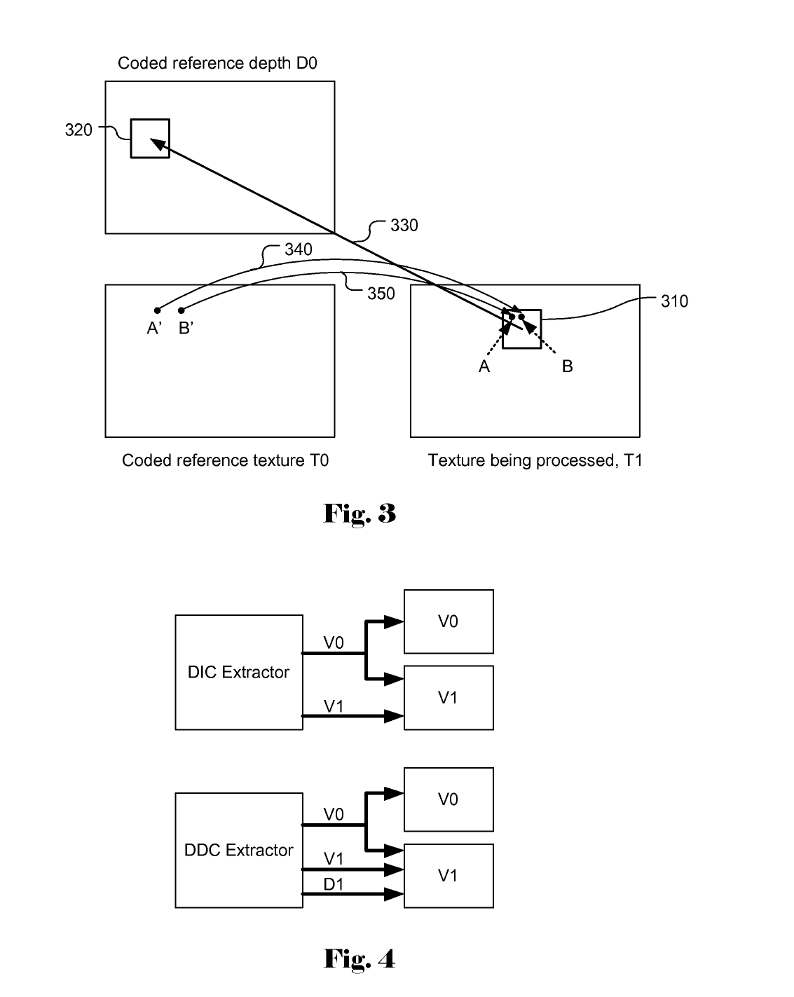

### DETAILED DESCRIPTION

As mentioned before, while the depth-dependent coding method (DDC) can improve coding efficiency over the depth-independent coding method (DIC), the dependency between texture and depth pictures as required by the DDC will cause compatibility issues with prior systems that do not support depth maps. Accordingly, a compatible DDC system is disclosed. The compatible DDC system allows an underlying 3D/multi-view coding system to selectively use either DDC or DIC by signalling syntax to indicate the selection.

In one embodiment of the present invention, a high level syntax design for compatible DDC system based 3D-HEVC is disclosed. For example, syntax elements for compatible DDC can be signalled in Video Parameter Set (VPS) as shown Table 1. DDC tools such as BVSP and DoNBDV are applied selectively as indicated by the syntax element associated the corresponding depth-dependent coding tool. An encoder can decide whether to utilize DDC or DIC depending on the application scenario. Moreover, an extractor (or a bitstream parser) can determine how to dispatch or extract bitstreams according to these syntax elements.

TABLE 1

| vps_extension2( ) { | Descriptor |
|---|---|
| ... | |
| if ( (layerId ! = 0) && !DepthLayerFlag[ layerId ] ) { | |
| iv_mv_pred_flag[ layerId ] | u(1) |
| iv_res_pred_flag[ layerId ] | u(1) |
| depth_dependent_flag[ layerId ] | u(1) |
| if( depth_dependent_flag[ layerId ] != 0 ){ | |
| view_synthesis_pred_flag [ layerId ] | u(1) |
| dv_refine_flag [ layerId ] | u(1) |
| } | |
| } | |
| if ( DepthLayerFlag[ layerId ] ) { | |
| if ( (layerId ! = 0) | |
| view_synthesis_pred_flag [ layerId ] | u(1) |
| ... | |
| } | |

Semantics of the exemplary syntax elements shown in the above example are described as follows. DepthLayerFlag[ layerId ] indicates whether the layer with layer₁₃ id equal to layerId is a depth layer or a texture layer.

Syntax element, depth_dependent_flag[ layerId ] indicates whether depth pictures are used in the decoding process of the layer with layer₁₃ id equal to layerId. When syntax element depth_dependent flag[ layerId ] is equal to 0, it indicates that depth pictures are not used for the layer with layer_id equal to layerId. When syntax element depth dependent flag[ layerId ] is equal to 1, it indicates that depth pictures may be used for the layer with layer_id equal to layerId. When syntax element depth dependent_flag[ layerId ] is not present, its value is inferred to be 0.

Syntax element, view_synthesis_pred_flag[ layerId ] indicates whether view synthesis prediction is used in the decoding process of the layer with layer_id equal to layerId. When syntax element view_synthesis_pred_flag[ layerId ] is equal to 0, it indicates that view synthesis prediction merging candidate is not used for the layer with layer_id equal to layerId. When syntax element view_synthesis_pred_flag[ layerId ] is equal to 1, it indicates that view synthesis prediction merging candidate is used for the layer with layer_id equal to layerId. When syntax element view_synthesis_pred_flag[ layerId ] is not present, its value shall be inferred to be 0.

Syntax element, do_nbdv_flag[ layerId ] indicates whether DoNBDV is used in the decoding process of the layer with layer_id equal to layerId. When syntax element do_nbdv_flag[ layerId ] is equal to 0, it indicates that DoNBDV is not used for the layer with layer_id equal to layerId. When syntax element do_nbdv_flag[ layerId ] is equal to 1, it indicates that DoNBDV is used for the layer with layer_id equal to layerId. When syntax element_do_nbdv_flag[ layerId ] is not present, its value shall be inferred to be 0.

The exemplary syntax design in Table 1 uses depth_dependent flag[ layerId ] to indicated whether depth-dependent coding is allowed. If the indication of the depth-dependent coding is asserted (i.e., depth dependent flag[ layerId ] !=0), two depth-dependent coding tool flags (i.e., view_synthesis_pred_flag[ layerId ] and do_nbdv_flag[ layerId ]) are incorporated. The depth-dependent coding tool flag is used to indicate whether the corresponding depth-dependent coding tool is used.

While the exemplary syntax design shown in Table 1 incorporates the compatible depth-dependent coding syntax in Video Parameter Set (VPS), the compatible depth-dependent coding syntax may also be incorporated in Sequence Parameter Set (SPS), Picture Parameter Set (PPS) or Slice Header. When the compatible depth-dependent coding syntax is incorporated in PPS, the compatible depth-dependent coding syntax in the Picture Parameter Set is the same for all pictures in a same sequence. When the compatible depth-dependent coding syntax is incorporated in Slice Header, the compatible depth-dependent coding syntax in the Slice Header is the same for all slices in a same picture.

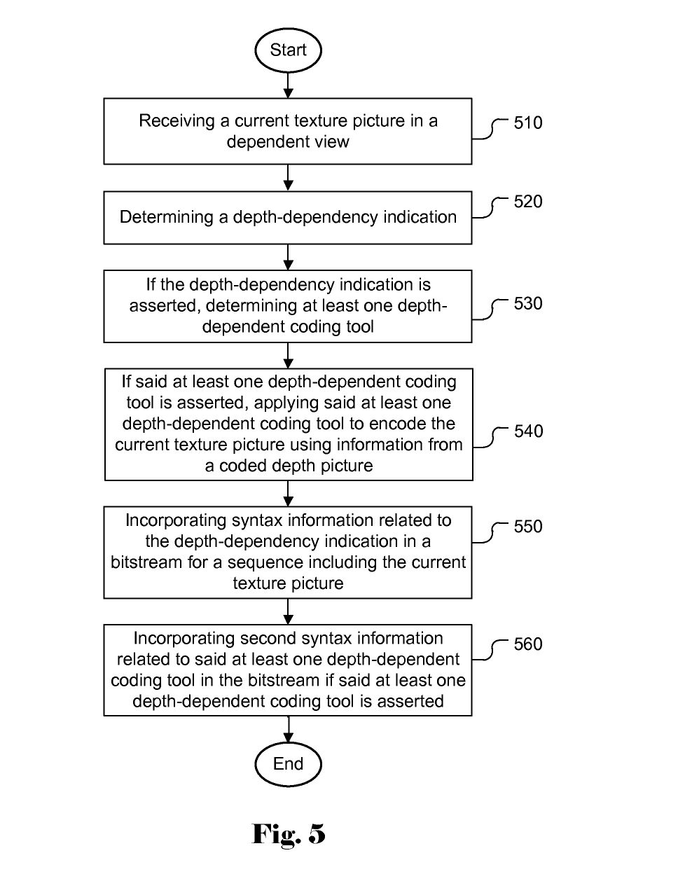

FIG. 5 illustrates an exemplary flowchart of a three-dimensional/multi-view encoding system incorporating compatible depth-dependent coding according to an embodiment of the present invention. The system receives a current texture picture in a dependent view as shown in step 510. The current texture picture may be retrieved from memory (e.g., computer memory, buffer (RAM or DRAM) or other media) or received from a processor. A depth-dependency indication is determined as shown in step 520. If the depth-dependency indication is asserted, at least one depth-dependent coding tool is determined as shown in step 530. If the depth-dependent coding tool is asserted, said at least one depth-dependent coding tool is applied to encode the current texture picture using information from a previously coded depth picture as shown in step 540. The syntax information related to the depth-dependency indication is incorporated in a bitstream for a sequence including the current texture picture as shown in step 550. The second syntax information related to said at least one depth-dependent coding tool in the bitstream if said at least one depth-dependent coding tool is asserted as shown in step 560.

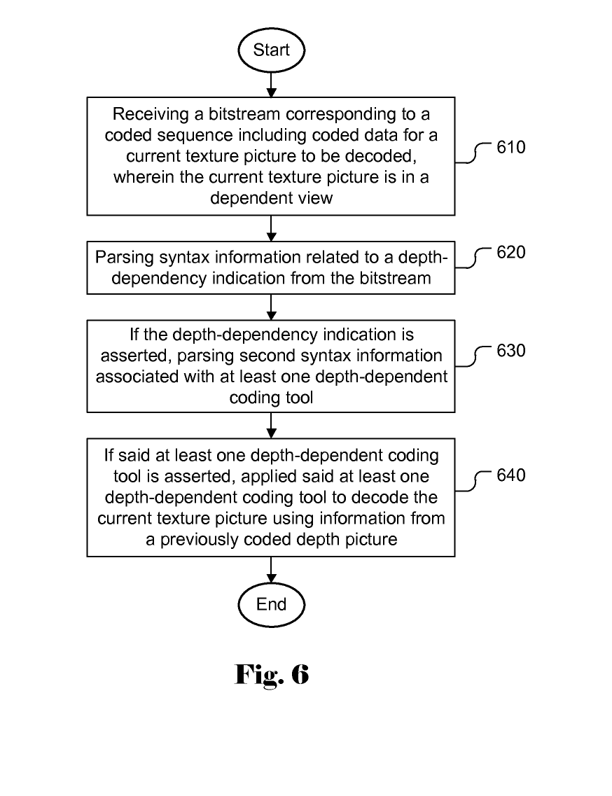

FIG. 6 illustrates an exemplary flowchart of a three-dimensional/multi-view decoding system incorporating compatible depth-dependent coding and depth-independent coding according to an embodiment of the present invention. A bitstream corresponding to a coded sequence including coded data for a current texture picture to be decoded is received as shown in step 610, wherein the current texture picture is in a dependent view. The bitstream may be retrieved from memory (e.g., computer memory, buffer (RAM or DRAM) or other media) or received from a processor. The syntax information related to a depth-dependency indication is parsed from the bitstream as shown in step 620. If the depth-dependency indication is asserted, then second syntax information associated with at least one depth-dependent coding tool is parsed as shown in step 630. If said at least one depth-dependent coding tool is asserted, said at least one depth-dependent coding tool is applied to decode the current texture picture using information from a previously decoded depth picture as shown in step 640.

The flowchart shown above is intended to illustrate an example of compatible depth-dependent coding according to an embodiment of the present invention. A person skilled in the art may modify each step, re-arranges the steps, split a step, or combine steps to practice the present invention without departing from the spirit of the present invention.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for three-dimensional or multi-view video decoding, the method comprising:
receiving a bitstream corresponding to a coded sequence including coded data for a current texture picture to be decoded, wherein the current texture picture is in a dependent view;
parsing syntax information related to a depth-dependency indication from the bitstream;
if the depth-dependency indication is asserted, parsing second syntax information associated with at least one depth-dependent coding tool; and
if said at least one depth-dependent coding tool is asserted, applied said at least one depth-dependent coding tool to decode the current texture picture using information from a previously decoded depth picture.

2. The method of claim 1, wherein the syntax information related to the depth-dependency indication is in Video Parameter Set (VPS) or Sequence Parameter Set (SPS).

3. The method of claim 1, wherein the syntax information related to the depth-dependency indication is in Picture Parameter Set (PPS).

4. The method of claim 3, wherein the syntax information related to the depth-dependency indication in the Picture Parameter Set is the same for all pictures in a same sequence.

5. The method of claim 1, wherein the syntax information related to the depth-dependency indication is in Slice Header.

6. The method of claim 5, wherein the syntax information related to the depth-dependency indication in the Slice Header is the same for all slices in a same picture.

7. The method of claim 1, wherein the second syntax information associated with said at least one depth-dependent coding tool is in Video Parameter Set (VPS), Sequence Parameter Set (SPS), Picture Parameter Set (PPS) or Slice Header.

8. The method of claim 7, wherein, if the second syntax information is in the Picture Parameter Set, the second syntax information in the Picture Parameter Set is the same for all pictures in a same sequence.

9. The method of claim 7, wherein, if the second syntax information is in the Slice Header, the second syntax information in the Slice Header is the same for all slices in a same picture.

10. The method of claim 1, wherein said at least one depth-dependent coding tool corresponds to Backward View Synthesis Prediction (BVSP) or Depth-oriented Neighboring Block Disparity Vector (DoNBDV).

11. The method of claim 10, wherein if the second syntax information associated with said at least one depth-dependent coding tool is not present in the bitstream, said at least one depth-dependent coding tool is not asserted.

12. A method for three-dimensional or multi-view video encoding, the method comprising:
receiving a current texture picture in a dependent view;
determining a depth-dependency indication;
if the depth-dependency indication is asserted, determining at least one depth-dependent coding tool;
if said at least one depth-dependent coding tool is asserted, applying said at least one depth-dependent coding tool to encode the current texture picture using information from a coded depth picture;
incorporating syntax information related to the depth-dependency indication in a bitstream for a sequence including the current texture picture; and
incorporating second syntax information related to said at least one depth-dependent coding tool if said at least one depth-dependent coding tool is asserted.

13. The method of claim 12, wherein the syntax information related to the depth-dependency indication is in Video Parameter Set (VPS) or Sequence Parameter Set (SPS).

14. The method of claim 12, wherein the syntax information related to the depth-dependency indication is in Picture Parameter Set (PPS), and the syntax information related to the depth-dependency indication in the Picture Parameter Set is the same for all pictures in a same sequence.

15. The method of claim 12, wherein the syntax information related to the depth-dependency indication is in Slice Header, and the syntax information related to the depth-dependency indication in the Slice Header is the same for all slices in a same picture.

16. The method of claim 12, wherein second syntax information associated with said at least one depth-dependent coding tool is incorporated in Video Parameter Set (VPS), Sequence Parameter Set (SPS), Picture Parameter Set (PPS) or Slice Header.

17. The method of claim 16, wherein, if the second syntax information is in the Picture Parameter Set, the second syntax information in the Picture Parameter Set is the same for all pictures in a same sequence.

18. The method of claim 16, wherein, if the second syntax information is in the Slice Header, the second syntax information in the Slice Header is the same for all slices in a same picture.

19. The method of claim 12, wherein said at least one depth-dependent coding tool corresponds to Backward View Synthesis Prediction (BVSP) or Depth-oriented Neighboring Block Disparity Vector (DoNBDV).
